(19) United States
(12) Patent Application Publication
(10) Pub. No.: US 2003/0159072 A1
(43) Pub. Date: Aug. 21, 2003

(54) Single sign-on for multiple network -based services

(75) Inventors: Douglas Bellinger, Ottawa (CA); Richard Burke, Vanier (CA); Thomas Phillips, Ottawa (CA); Antonino Scaffidi Argentina, Gloucester (CA); Andrea Baptiste, Ottawa (CA); Gaetan Delahousse, Ottawa (CA); Geoff Stewart, Ottawa (CA); Wendy Raoux, Ottawa (CA); Luc Richard, Greely (CA); Stephanie Bazin, Ottawa (CA); Scott Brookes, Ottawa (CA); Patrick Rhude, Dunrobin (CA)

Correspondence Address: T. Lester Wallace, Patent Attorney, Suite 280, 7041 Koll Center Parkway, Pleasanton, CA, 94566, US

(73) Assignee: Atreus Systems Corp.

(21) Appl. No.: 10/357,852

(22) Filed: Feb. 3, 2003

Related U.S. Application Data
(60) Provisional application No. 60/354,268, filed on Feb. 4, 2002.

(51) Int. Cl. H04L 9/00

(52) U.S. Cl. 713/202; 713/168

(57) ABSTRACT

A network-based service creation platform automates and simplifies many tasks associated with defining new network service offerings to network users, publishing the new service offerings to the users, handling the subscription and registration of subscribers to the new service, billing for the service, and otherwise managing the service. In one embodiment, once a user is authenticated a first time, the user is then automatically authenticated for multiple network-based services without having to perform separate manual logins for each service. Moreover, the user is authenticated for a plurality of networking devices and/or computing devices used to provide the services.

### CROSS REFERENCE TO RELATED APPLICATION

This application claims the benefit under 35 U.S.C. §119 of the provisional application serial No. 60/354,268, entitled “Software Platform For Managing Network-Based Services”, filed Feb. 4, 2002. The subject matter of provisional application serial No. 60/354,268 is incorporated herein by reference.

### CROSS REFERENCE TO COMPACT DISC APPENDIX

The Compact Disc Appendix, which is a part of the present disclosure, includes one recordable Compact Disc (CD-R) containing information that is part of the disclosure of the present patent document. The Compact Disc contains: the directory file AMP, 1.07 MB, written to disc Jan. 15, 2003; the directory file PORTAL, 1.35 MB, written to disc Jan. 15, 2003; the directory file XLINK, 1.69 MB, written to disc Jan. 15, 2003; and the file CD Appendix Title Page.txt, 372 bytes, written to disc Jan. 15, 2003. The AMP and XLINK directories contain xAuthority core server source code written primarily in XML and Perl. The PORTAL directory contains source code for the portal server. The PORTAL source code is mostly HTML pages containing Javascript, Perl scripts and Bash script. All the material on the Compact Disc is hereby expressly incorporated by reference into the present application.

A portion of the disclosure of this patent document contains material that is subject to copyright protection. The copyright owner of that material has no objection to the facsimile reproduction by anyone of the patent document or the patent disclosure, as it appears in the Patent and Trademark Office patent files or records, but otherwise reserves all copyright rights.

### TECHNICAL FIELD

The present invention relates to setting up network-based services, and more particularly to a method by which a user can be authenticated for multiple network-based services through a single sign-on.

### BACKGROUND

Network-based services usually involve the use of multiple hardware devices and/or multiple software applications that must each be configured. Configuring the devices and applications often involves a skilled technician shutting down the devices, configuring the applications, installing software service drivers, and restarting the devices. This manner of setting up network-based services can be a relatively time-intensive, manual task. Not only can this setting up of a network-based service for a user be time consuming, but the setting up of the a second network-based service for the same user can also be time consuming.

Accordingly, the above-described setting up of multiple network-based services generally involves a technician being involved every time a service is provided to a user. This is undesirable. A system is sought that eliminates the cost, time, complexity and service interruption associated with setting up such network-based services.

### BRIEF DESCRIPTION OF THE DRAWINGS

FIG. 1 is a simplified diagram of a system in accordance with some embodiments of the present invention.

FIG. 2 is a flowchart of a “single sign-on” aspect of the present invention.

FIG. 3 is a flowchart of a “service creation process” aspect of the present invention.

FIGS. 4A, 4B and 4C are screenshots of the publication, subscription, and registration processes in accordance with the “service creation process” aspect of FIG. 3.

FIG. 5 is a flowchart of a “modular service driver” aspect of the present invention.

FIG. 6 is a simplified diagram of a system for carrying out the “modular service driver” aspect of FIG. 5.

FIG. 7 is a flowchart of a “publish to query” aspect of the present invention.

FIG. 8 is a very simplified diagram of user directories in accordance with the “publish to query” aspect of FIG. 7.

### DETAILED DESCRIPTION

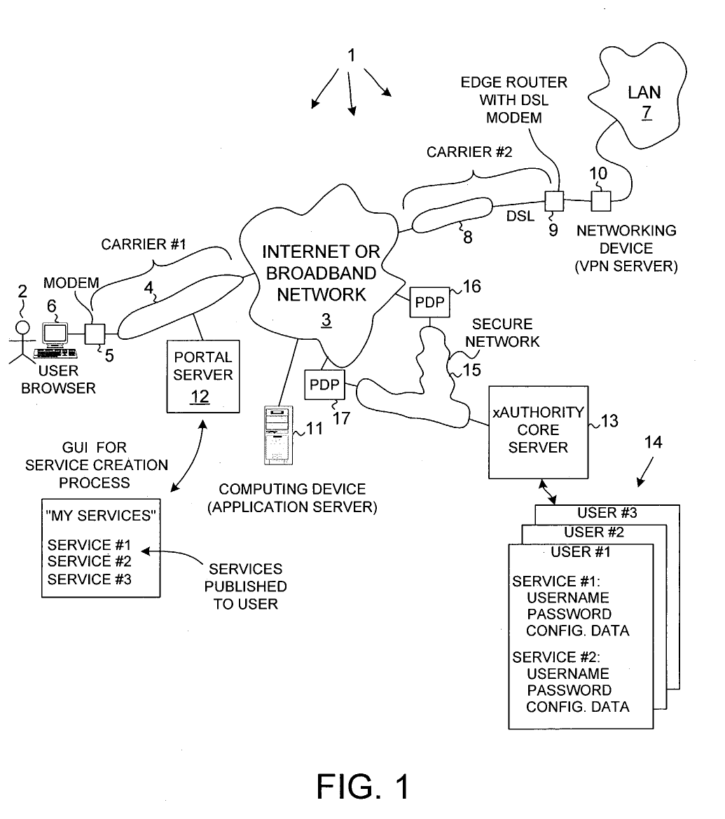

FIG. 1 is a diagram of a system 1 in accordance with some embodiments of the present invention. A first carrier (carrier #1) provides a user 2 access to the internet 3 via network 4 and modem 5. The user 2 accesses web pages via a browser executing on the user's computer 6. In this example, the first carrier (for example, a cable operator such as AT&T Broadband) desires to sell to user 2 certain other services including a “networking” service and a “computing” service.

In the illustrated example, the “networking service” is a VPN (virtual private network) service that provides secure communications from user's computer 6 to another computer on a LAN (local area network) 7. Access to LAN 7 is provided via the network 8 of a second carrier (carrier #2), an edge router 9 having a DSL modem, and a VPN server 10. Carrier #2 may, for example, be a local telephone company such as, for example, Bell Canada.

In the illustrated example, the “computing service” is access to the Microsoft Exchange program (an application program) that is executing on a remote application server 11.

User 2 uses his/her browser to access a sign-on web page served by a portal server 12. Portal server 12 may, for example, be owned and operated by the first carrier and may be coupled to the network 4 of the first carrier as illustrated. The web page queries user 2 for the user's username and password. The user types in a username and an associated password and is authenticated by the xAuthority Core Server 13. Once the user has supplied the username and password and is thereby authenticated, the user is presented with various services to which user 2 can subscribe. In the present example, one of the services is VPN access to LAN 7. Another of the services is use of the Microsoft Exchange application program executing on server 11. User 2 uses various web pages served by portal server 12 to sign up for these services. Information necessary for user 2 to access the services such as, for example, any necessary usernames, passwords, billing information, and configuration data are stored on an xAuthority core server 13. In this particular example, this information is transferred from portal server 12 to xAuthority core server 13 via a secure network connection (not illustrated). In one embodiment, this connection uses Secure Socket Layer communications between the Portal Server 12 and the xAuthority Core Server 13. In FIG. 1, user profiles 14 illustrate the information necessary for various users, including user 2, to gain access to each of the subscribed to services.

Single Sign-On:

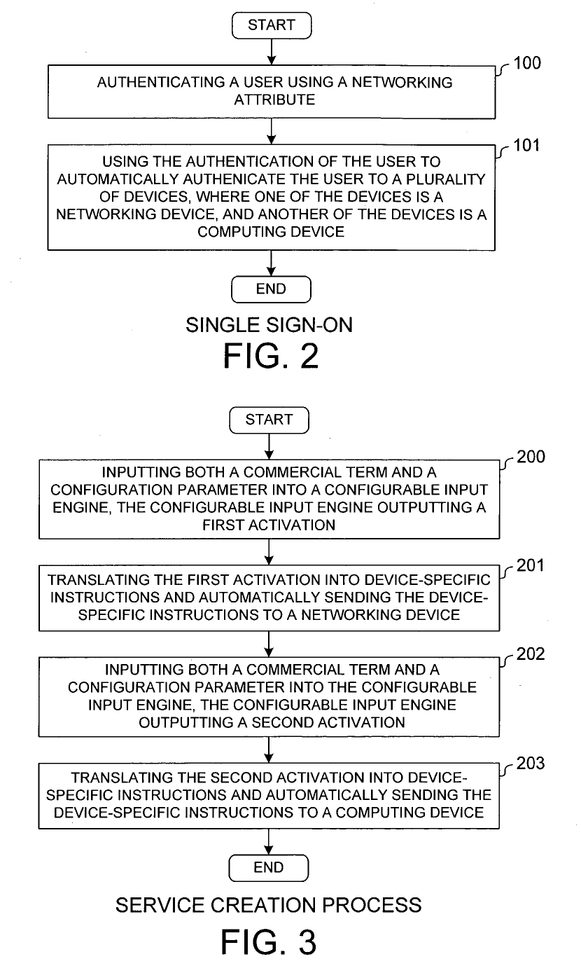

FIG. 2 is a flowchart in accordance with a “single sign-on” aspect of the present invention. In a first step (step 100), user 2 is authenticated using a “networking attribute”. In addition to using the networking attribute to authenticate the user, other information can be used but at least one networking attribute is used.

Examples of “networking attributes” include, but are not limited to: a location, a quality of service, an access mechanism, a physical port, an IP address, and a connection speed. In the present example, the networking attribute used is the physical port into which the user plugs his/her computer to gain network access. More particularly, the physical port is within a building, access to which is controlled by the user. It is therefore agreed that network access gained via the physical port is sanctioned, at least to some degree, by the user.

In addition to the networking attribute, other information may also be used to authenticate user 2. For example, the sign-on web page served by portal server 12 may solicit from user 2 certain computing attributes such as, for example, the user's username and password.

Once the networking attribute and any other computing attributes are collected, the portal server 12 forwards those attributes to xAuthority core server 13. If xAuthority core server 13 determines that the received login information meets authentication criteria, then user 2 is said to have been “authenticated”.

Once authenticated in step 100, user 2 is automatically authenticated to a plurality of other devices (step 101). In the “single sign-on” aspect of the present invention, the other devices include both a “networking device” and a “computing device”. In the example of FIG. 1, the networking device is VPN server 10. xAuthority core server 13 accesses any authentication information (for example, passwords and/or configuration data) necessary to authenticate user 2 to VPN server 10 and forwards this information to VPN server 10. The authentication information is forwarded in the form of an “activation” via a secure network 15 to a policy distribution point (PDP) 16. PDP 16 converts the activation into a data format and protocol required by networking device 10. A particular networking device may, for example, receive authorization information and configuration data only via a certain proprietary protocol. In such cases, PDP 16 supplies the authorization information and configuration data in the required proprietary protocol. The authorization information and configuration data passes from PDP 16, through internet 3, through network 8 of carrier #2, through edge router 9, and to networking device (VPN router) 10. In this way, the authentication information for user 2 is supplied to networking device 10, and user 2 is automatically authenticated on networking device 10.

In addition to being automatically authenticated to networking device 10, user 2 is automatically authenticated to computing device 11. xAuthority core server 13 outputs an activation to PDP 17 via secure network 15. PDP 17 converts the activation into authentication information and configuration data that is in the correct format and protocol for application server 11. The authentication information and configuration data is received by application server 11 such that user 2 is authenticated onto computing device 11.

Once properly authenticated, user 2 can use the networking device 10 and the computing device 11 without having to perform separate manual logins for each. As such, the method of FIG. 2 is called a “single sign-on” method. Although the single sign-on of user 2 as explained above involves the use of a networking attribute in initial step 100, a user can also be “single sign-on” authenticated to a plurality of devices without using a networking attribute if desired.

Service Creation Process:

FIG. 3 is a flowchart in accordance with a “service creation process” aspect of the present invention. Once the service provider (for example, carrier #1 in the diagram of FIG. 1) has conceived of a service to be offered to end-users (for example, user 2), a system administrator of the service provider accesses a configurable input engine on xAuthority core server 13. The configurable input engine provides an administrative web interface (a graphical user interface) for this purpose. The system administrator accesses the administrative web interface, logs on to the xAuthority core server 13, and proceeds to define the new service to be offered.

In the following example, the service provider is carrier #1. The new service to be offered to user 2 is the establishment of a virtual private network (VPN) between user 2 and a computer on LAN 7. To set up such a VPN service, VPN server 10 must be configured.

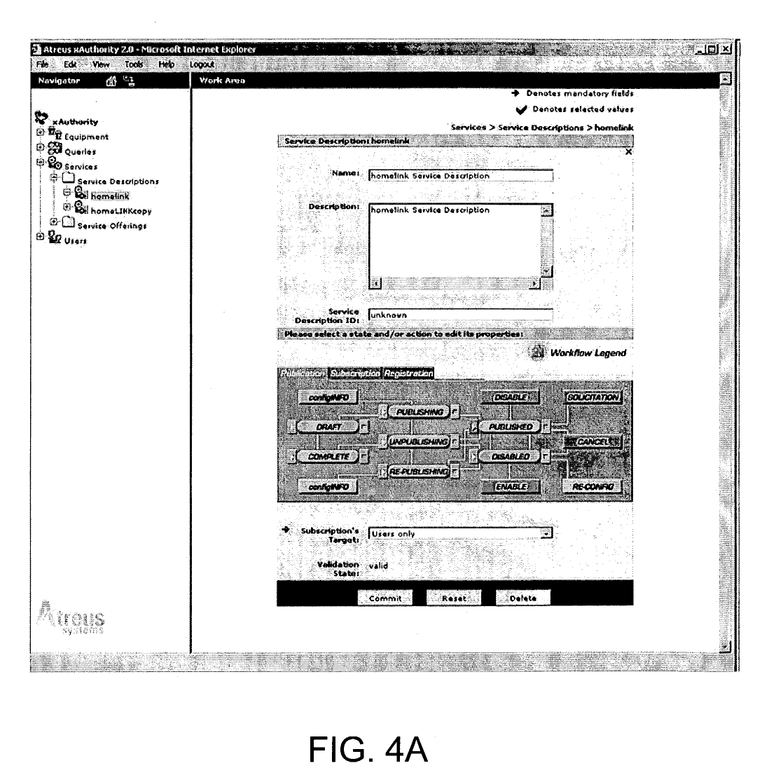

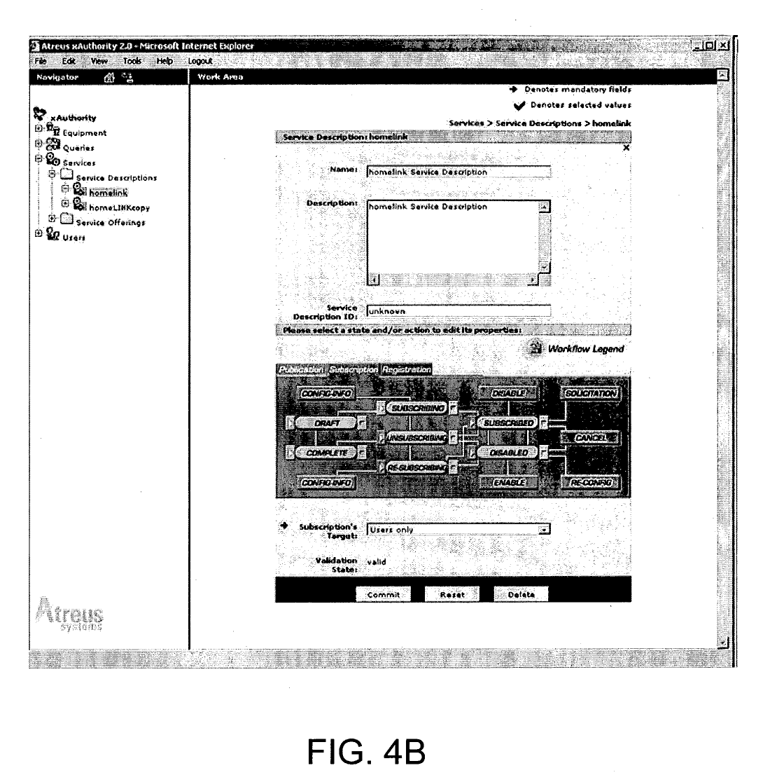

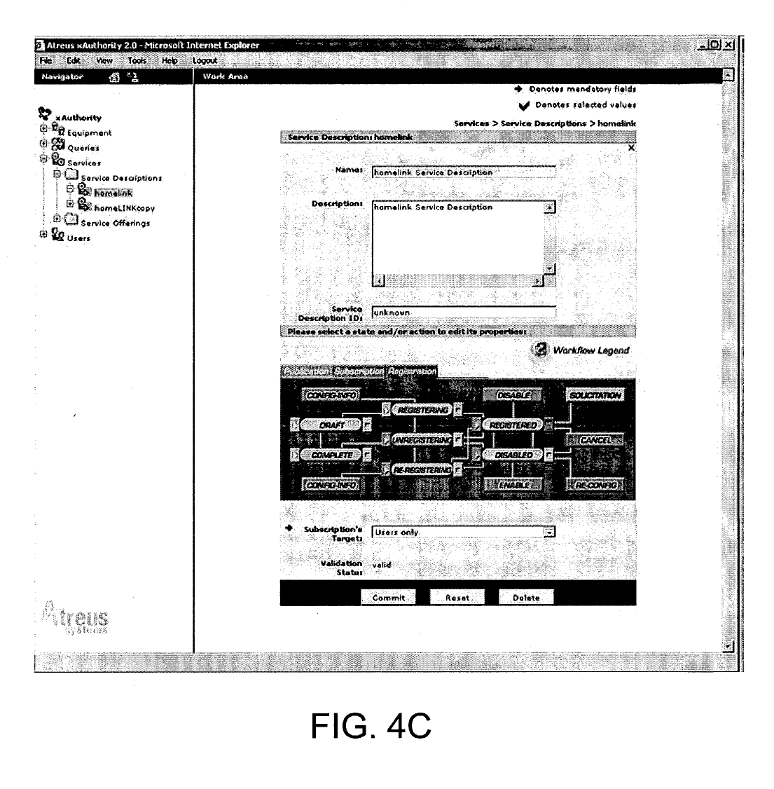

FIG. 4A is a screen shot of a “publication” page of the administrative web interface of the configurable input engine. In the present example, the system administrator of carrier#1 uses the “publication”, “subscription” and “registration” pages to add service description attributes into the configurable input engine. In the example of FIG. 3, both a “commercial term” as well as a “configuration parameter” are input (step 200) into the configurable input engine. Examples of commercial terms include, but are not limited to: how much to pay, a payment method, a duration of service, and a frequency of payment. Examples of configuration parameters include, but are not limited to: bandwidth required, a username, a password, an IP address, and a location.

In the presently described example where a VPN service is being set up for user 2, the system administrator enters, using the “registration” page, meta-level information that describes the required VPN configuration parameters to be sent to the VPN server upon registration of the user. Meta-level information includes a parameter name, parameter type, and number of occurrences. The meta-level information, in this example, is “User Name” (a thirty two character string), “User Password” (a 16 character string), and the user's VPN IP address (an octet string). The sum of all the service description attributes defines the service offering.

Once the service offering has been defined, it is “published” (i.e., offered) to users. In the present example, it is published to user 2. Once published, user 2 may subscribe to the new service by entering into a business agreement with the service provider (in this case, carrier#1) to receive and pay for the service. What happens when user 2 subscribes to the newly offered service is defined by the service provider system administrator using the “subscription” page of the administrative web interface of the configurable input engine. FIG. 4B is a screen shot of the “subscription” page.

In the presently described example where a VPN service is being offered to user 2, an e-commerce application on portal server 12 allows the user to choose a method of payment and commercial terms from those defined within the service offering. The available payment methods in the presently described example are “invoice” or “credit card”. The terms are a dollar amount billed per month for twelve consecutive months, or a lump sum yearly amount.

Once user 2 has subscribed, user 2 can add himself/herself to the list of customers who utilize the service. This is known as “registration”. What happens when customer 2 attempts to register is defined by the system administrator using the “registration” page of the graphical user interface of the configurable input engine. FIG. 4C is a screen shot of the “registration” page. In this example where a VPN service is being set up for user 2, the “User Name”, and “User Password”, and VPN IP address are entered from portal server 12 using a VPN registration page.

Once the user has accepted the commercial terms and the configuration parameter has been input into the configurable input engine, then the configurable input engine outputs a first activation. The first activation is in XML form and is transmitted using secure HTTP across secure network 15 to policy distribution point 16. PDP 16 includes one or more “service drivers”. The appropriate one of these service drivers translates the XML of the first activation into device-specific instructions accepted by VPN server 10 (a networking device). The activation, as represented by these instructions, is then encrypted and sent via internet 3 and network 8 and edge router 9 to VPN server 10. The instructions then configure VPN server 10 as appropriate to set up the new service.

In the method of FIG. 3, the same configuration input engine is used to output policies for computing devices. Accordingly, in another step (step 202), both a commercial term as well as a configuration parameter are input into the configurable input engine, but this time the activation generated is to be sent to a computing device rather than a networking device.

Consider the example where carrier#1 wants to offer user 2 a new computing service that is provided by remote application server 11. One example of such a computing service is access to a mail server (for example, a Microsoft Exchange mail server) executing on server 11. It may be somewhat expensive for small companies to operate and maintain such a mail server themselves. Carrier#1 may, however, operate one such mail server and sell access to many small companies, thereby employing economies of scale to reduce the cost of the service to the small companies.

After carrier#1 has defined the new service using the publication page of FIG. 4A, the subscription page of FIG. 4B, and the registration page of FIG. 4C, and after user 2 has subscribed and registered, then the configurable input engine in xAuthority core server 13 outputs a second activation. This second activation is in XML and is transmitted from xAuthority core server 13 via secure network 15 to a PDP close to computing device 11. In the example of FIG. 1, that PDP is PDP 17.

A service driver in PDP 17 then translates the second activation into device-specific instructions for application server 11. The instructions are encrypted and then sent from PDP 17, via internet 3, to computing device 11. The second activation, communicated in this way to application server 11, configures the application server to set up the computing server for use by user 2.

In both steps 200 and 202, new services are defined and policies generated without the service provider administrator having to do any low-level computer programming. Rather, the service provider administrator enters commercial terms and/or configuration data into a single configuration input engine using a high-level graphical user interface. The same configurable input engine is usable to generate policies for both networking devices as well as for computing devices. For a more detailed treatment of a method that allows a user to self-activate a network-based service, see U.S. patent appplication Ser. No. 10/213,043 entitled “System And Method For Setting Up User Self-Activating Network-Based Services,” by Bellinger et al., filed Aug. 5, 2002, which is incorporated herein by reference.

Modular Service Driver:

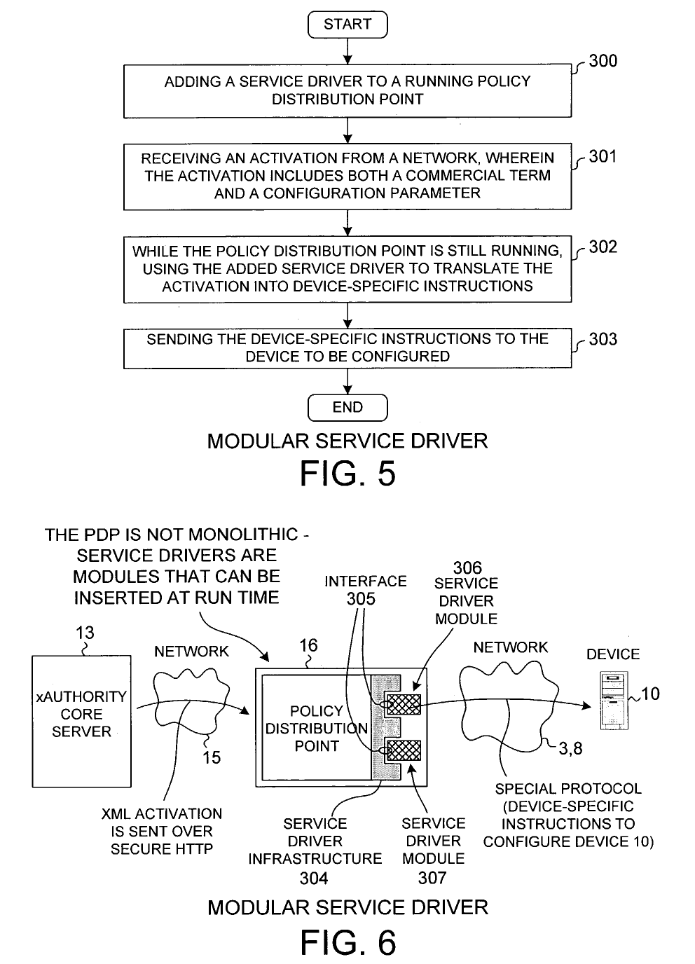

FIG. 5 is a flowchart of a method in accordance with a “modular service driver” aspect of the present invention. FIG. 6 is a simplified diagram of system 1 for carrying out the method of FIG. 5.

In accordance with this method, the software executing on the policy distribution point (PDP) 16 of system 1 is not a single monolithic piece of code, but rather the software has a service driver infrastructure portion 304. Service driver infrastructure portion 304 has a predefined standard interface 305 for coupling to service driver modules 306 and 307. A service driver can be installed by plugging it into standard interface 305. This installation of a service driver can be done while the remainder of the PDP software is running.

In a first step (step 300) of the method of FIG. 5, a service driver 306 is added to PDP 16 while PDP 16 is running. PDP 16 receives (step 301) an activation from xAuthority server 13 in XML over secure HTTP via secure network 15. The activation includes both a commercial term as well as a configuration parameter.

Then, while the PDP software of PDP 16 is still running, the newly added service driver module 306 translates (step 302) the activation into device-specific instructions suitable for configuring device 10. As set forth in connection with the example of FIG. 1, the device-specific instructions are encrypted and then sent from PDP 16 (step 303) to networking device 10 to be configured. In the example of FIG. 1, the encrypted device-specific instructions pass from PDP 16, through internet 3, through network 8, through edge router 9, and to networking device 10.

The example of a networking device being configured is set forth only as an example. In other embodiments, a service driver is added to a running PDP and that service driver is used to send device-specific instructions to a computing device, such as for example, computing device 11 of the system of FIG. 1. For a more detailed treatment of PDPs and service drivers and how they configure devices that are used to provide network-based services, see U.S. patent application Ser. No. 10/223,846 entitled “Policy Distribution Point For Setting Up Network-Based Services,” by Bellinger et al., filed Aug. 19, 2002, which is incorporated herein by reference.

Publish To Query:

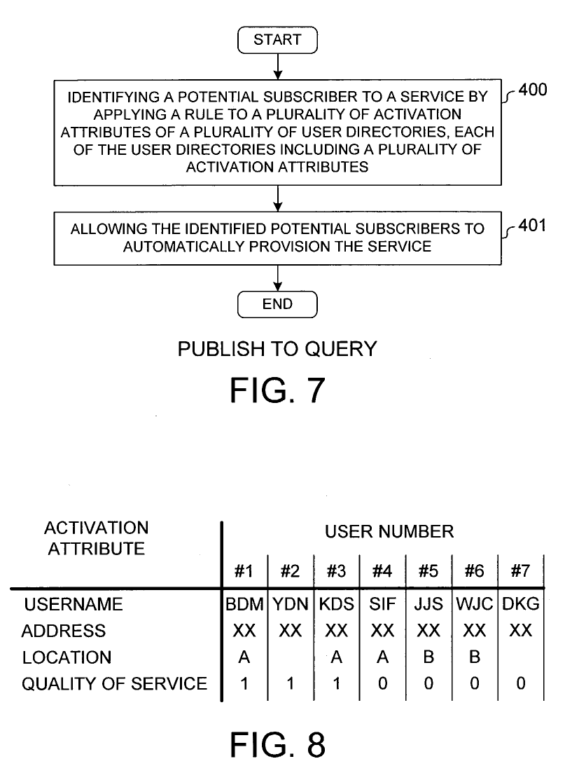

FIG. 7 is a flowchart of a method of a “publish to query” aspect in accordance with the present invention. In a first step (step 400), a potential subscriber to a service is identified by applying a rule to a plurality of attributes of a plurality of user directory entries, where each of the directory entries includes a plurality of activation attributes.

FIG. 8 is a very simplified diagram of a set of user directories. In the diagram, each column lists activation attributes for a different user directory. If, for example, the rule were to identify those users located in building A, then users #1, #3 and #4 would be identified. If the rule were to identify those users located in building A with a quality of service of 1, then user number #1 and #3 would be identified. Once the potential subscribers are identified, the identified potential subscribers are allowed to automatically provision (step 401) the service. For example, a web page may be provided to the identified potential subscribers. The identified potential subscribers can then elect to provision the service by selecting a link on the web page.

The term policy is not used in this patent document (and in the claims of this document) in the way the term policy was used in provisional application serial No. 60/354,268. Sometimes the term “service driver module” is used to refer to a service driver that has been configured and installed on a PDP.

Although the present invention has been described in connection with certain specific embodiments (for example, the documents incorporated into this patent document above) for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
(a) using a first networking attribute to perform an authentication a first user;
(b) using the authentication of the first user to automatically authenticate the first user to a first plurality of devices;
(c) using a second networking attribute to perform an authentication a second user; and
(d) using the authentication of the second user to automatically authenticate the second user to a second plurality of devices,
wherein (a) and (b) and (c) and (d) are performed by a software program, wherein the first plurality of devices includes a networking device, and wherein the second plurality of devices includes a computing device.

2. The method of claim 1, wherein the first networking attribute is taken from the group consisting of: an indication of a location of the first user, an indication of a quality of service, an indication of an access mechanism, an indication of a physical port, an IP address, and a connection speed.

3. The method of claim 1, wherein the networking device is taken from the group consisting of: a router, a VPN server, and a firewall.

4. The method of claim 1, wherein an application program runs on the computing device.

5. The method of claim 4, wherein the application program is an email application program.

6. A method, comprising:
(a) inputting a first commercial term and a first configuration parameter into a configurable input engine, the configurable input engine defining a first service;
(b) translating the first service into a first policy; and
(c) automatically sending the first policy to a networking device;
(d) inputting a second commercial term and a second configuration parameter into the configurable input engine, the configurable input engine defining a second service;
(e) translating the second service into a second policy; and
(f) automatically sending the second policy to a computing device.

7. The method of claim 6, wherein the configurable input engine has a high level graphical user interface, and wherein a first user uses the graphical user interface to define the first service without doing any computer programming.

8. The method of claim 7, wherein the first user uses the graphical user interface by picking selected ones of a plurality of graphically illustrated steps, wherein in response to the first user picking the selected steps the selected steps are executed, execution of the selected steps resulting in the first commercial term and the first configuration parameter being input into the configurable input engine.

9. The method of claim 6, wherein the first policy is sent to the networking device in the form of first device-specific instructions, the first device-specific instructions being specific to the networking device, wherein the second policy is sent to the computing device in the form of second device-specific instructions, the second device-specific instructions being specific to the computing device.

10. The method of claim 6, wherein each of the first commercial term and the second commercial term is taken from the group consisting of: a payment amount, an indication of a payment method, an indication of a duration of service, and an indication of a frequency of payment.

11. The method of claim 6, wherein each of the first configuration parameter and the second configuration parameter is taken from the group consisting of: an indication of a bandwidth requirement, a username, a password, an IP address, and an indication of a location.

12. The method, comprising:
(a) adding a service driver to a running policy distribution point; and
(b) while the policy distribution point is still running, receiving a policy from a network and using the added service driver to translate the policy into device-specific instructions, wherein the policy includes both a commercial term and a configuration parameter.

13. The method of claim 12, wherein the policy distribution point has a predefined interface for service drivers, the predefined interface facilitating installation the service driver into the policy distribution point at run time while the policy distribution point is running.

14. The method of claim 12, wherein the policy distribution point is not a monolithic policy distribution point, but rather is a modular policy distribution point comprising a service driver infrastructure portion and one or more service drivers.

15. The method of claim 12, wherein the policy is translated from XML into the device-specific instructions.

16. A method, comprising:
(a) identifying a potential subscriber to a service by applying a rule to a plurality of activation attributes of a plurality of user directories, each of the user directories including a plurality of activation attributes; and
(b) allowing the identified potential subscriber to automatically provision the service.

17. The method of claim 16, wherein (b) involves providing a web page to the potential subscriber, the web page including a selectable indication of the service.

18. The method of claim 17, further comprising:
(c) provisioning the service for the identified potential subscriber in response to the identified potential subscriber selecting the selectable indication on the web page.

19. The method of claim 16, wherein the activation attributes are taken from the group consisting of: a username, an IP address, an indication of a location, an indication of quality of service.

20. The method of claim 16, wherein not all of the user directories include the same set of activation attributes.
